(19) United States
(12) Patent Application Publication
(10) Pub. No.: US 2017/0244164 A1
(43) Pub. Date: Aug. 24, 2017

(54) SYNTHESIZING CROSS-POLARIZED BEAMS WITH A PHASED ARRAY

(71) Applicant: Blue Danube Systems, Inc., Warren, NJ (US)

(72) Inventors: Gregg S. Nardozza, Madison, NJ (US); Ronald A. Marino, Jackson, NJ (US)

(21) Appl. No.: 15/435,743

(22) Filed: Feb. 17, 2017

Related U.S. Application Data
(60) Provisional application No. 62/296,704, filed on Feb. 18, 2016.

(51) Int. Cl. H01Q 3/26; H01Q 21/22; H01Q 1/24; H01Q 21/24

(52) U.S. Cl. CPC H01Q 3/26; H01Q 21/24; H01Q 21/22; H01Q 1/246

(57) ABSTRACT

A method involving providing a phased array antenna system having M antenna element pairs, each antenna element pair including a vertically oriented antenna element and a horizontally oriented antenna element; and with the phased array antenna system, generating n cross-polarized beams Bj, where j=1 . . . n, each cross-polarized beam Bj having either a +45° polarization or a −45° polarization, wherein generating each cross-polarized beam Bj involves: with the vertically polarized antenna elements of Nj antenna element pairs among the M antenna element pairs, generating a vertically polarized beam BVj; and with the horizontally polarized antenna elements of the Nj antenna element pairs, generating a horizontally polarized beam BHj, wherein the vertically polarized beam BVj and the horizontally polarized beam BHj are identically shaped and directed and wherein a superposition of the beams BVj and BHj produces the cross-polarized beam Bj.

This application claims the benefit under 35 U.S.C. 119(e) of Provisional Application Ser. No. 62/296,704, filed Feb. 18, 2016, entitled “An Optimized Cross-Polarized Array Architecture,” the entire contents of which are incorporated herein by reference.

### FIELD OF THE INVENTION

The present disclosure relates generally to wireless communication systems such as are used in cellular or wireless local area networks and, more particularly, to multi-beam phased array wireless communication systems.

### BACKGROUND

FIG. 1 illustrates a phased array antenna system. It includes a base station 16 that communicates with a remote phased array radio head 14 connected to a phased array antenna 12. In this system, multiple beams can be formed within a sector, some perhaps overlapping and some not. In this particular embodiment, the base station 16 sends four transmit signal streams Tx1 Tx2, Tx3, and Tx4 to the remote radio head 14 and receives from the remote radio head 14 four received signal streams Rx1, Rx2, Rx3, and Rx4. The remote radio head 14, in turn, sends four transmit beam signal streams Tb1, Tb2, Tb3, and Tb4, to the antenna array 12 to generate four beams, one beam for each transmit beam signal stream, Tx1, Tx2, Tx3, and Tx4, and it receives four signal streams Rb1, Rb2, Rb3, and Rb4 from the antenna array 12.

The phased array antenna 12 might typically be an array of cross-polarized antenna pairs with one antenna element of each antenna pair having a +45° polarization (or slant) and the other having a −45° polarization (or slant). There is a reason for using the +/−45° slant pairs. The +/−45° slant pairs, which generate corresponding +/- 45° polarized beams, provide two basically identical channels with regard to propagation. Maximum diversity gain is achievable when both channels are identical. In contrast, vertical and horizontal (H-V) pairs (i.e., 0°/90° orientations), although similarly orthogonal, do not provide two identical channels due to dissimilar propagation properties.

### SUMMARY

In general, in one aspect, the invention features a method involving: providing a phased array antenna system having M antenna element pairs, each antenna element pair including a vertically oriented antenna element and a horizontally oriented antenna element, wherein M is an integer greater than 1; and with the phased array antenna system, generating n cross-polarized beams Bj, where j=1 . . . n, each cross-polarized beam Bj having either a +45° polarization or a −45° polarization and wherein n is an integer equal to or greater than 1, wherein generating each cross-polarized beam Bj involves: with the vertically polarized antenna elements of Nj antenna element pairs among the M antenna element pairs, wherein Nj is an integer, generating a vertically polarized beam BVj; and with the horizontally polarized antenna elements of the Nj antenna element pairs, generating a horizontally polarized beam BHj, wherein the vertically polarized beam BVj and the horizontally polarized beam BHj are identically shaped and directed and wherein a superposition of the beams BVj and BHj produces the cross-polarized beam Bj, and wherein Nj for j=1 . . . n is an integer such 2≦Nj≦M.

Other embodiments include one or more of the following features. The parameter n≧1. At least one Nj equals M or possibly all Nj for j=1 . . . n equal M. The M antenna element pairs are arranged to form a one-dimensional array or alternatively, a two-dimensional array. Then cross-polarized beams Bj, for j=1 . . . n, are transmit beams or alternatively, they are receive beams. Each cross-polarized beam Bj, for j=1 . . . n, is aimed in a different direction. A subset of the n cross-polarized beams Bj, for j=1 . . . n has a +45° polarization and a different subset of the n cross-polarized beams Bj, for j=1 . . . n has a −45° polarization. Generating the vertically polarized beam BVj involves generating the vertically polarized beam BVj for a signal transmission Tj and generating the horizontally polarized beam BHj involves generating the horizontally polarized beam BHj for the signal transmission Tj with either a 0° or 180° phase shift. Alternatively, generating the horizontally polarized beam BHj involves generating the horizontally polarized beam BHj for a signal transmission Tj and generating the vertically polarized beam BVj involves generating the vertically polarized beam BVj for the signal transmission Tj with either a 0° or 180° phase shift.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 depicts a phased array base station system functional arrangement that uses an array of cross-polarized antenna element pairs to generate four beams.

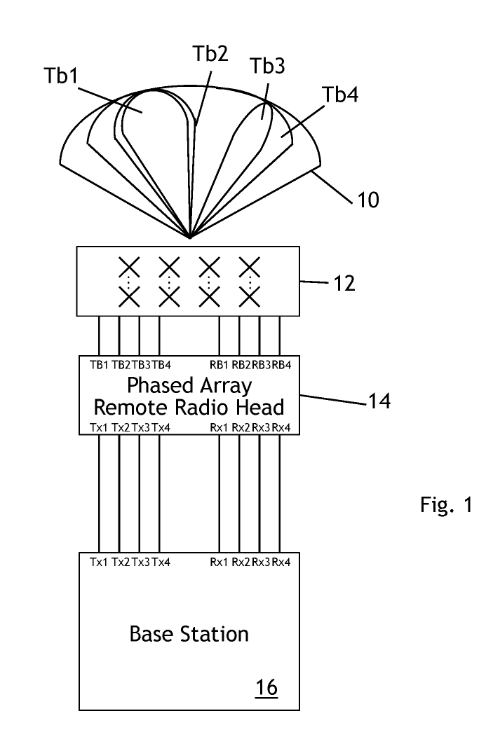

FIGS. 2a and 2b illustrate two approaches to generating a +45° polarized beam, one approach employing +45° oriented antenna elements and the other approach employing H-V)(0°/90° antenna elements.

FIGS. 3a and 3b illustrate two approaches to generating a −45° polarized beam, one approach employing −45° oriented antenna elements and the other approach employing H-V)(0°/90° antenna elements.

FIGS. 4a and 4b depict part of a conventional phased array antenna system for generating a transmit beam and a corresponding part of a phased array antenna system that embodies concepts introduced herein.

FIGS. 5a and 5b illustrate two approaches to receiving a +45° polarized beam, one approach employing +45° oriented antenna elements and the other approach employing H-V)(0°/90° antenna elements.

FIG. 6 depicts part of a phased array antenna system for receiving +/−45° polarized signals and that embodies concepts introduced herein.

FIG. 7 helps illustrate an advantage of the new beam forming approach described herein.

FIG. 8 depicts a phased array base station system functional arrangement that employs an array of H-V antenna element pairs to generate and receive four beams.

FIG. 9 is an exemplary high-level block diagram showing the internal structure of an exemplary radio head and phased array antenna.

FIG. 10 is an exemplary high-level block diagram of a Tx/Rx module such as is shown in FIG. 9.

FIG. 11 is an exemplary block diagram of the transmitter side of an active antenna array system showing the circuitry for only one of multiple transmit beams.

FIG. 12 is an exemplary block diagram of the receiver side of an active antenna array system showing the circuitry for only one of multiple receive beams.

In the preceding figures, like elements may be identified with like reference numbers.

### DETAILED DESCRIPTION

Presented herein is a novel way to architect a phased array antenna system using H-V)(0°/90° antenna element pairs instead of +/−45° cross-polarized element pairs. As noted above, the reason conventional systems use +/−45° slant pairs is that the +/−45° slant pairs provide two identical channels with regard to propagation, namely, a +45° polarized beam and a −45° polarized beam. Horizontal and vertical polarized beams (generated by the H-V or 0°/90° orientated antenna element pairs) do not provide identical channels. However, using +/−45° slant pairs limits the number of elements in the phased array (and correspondingly, the number of power amplifiers or antenna element drivers) that can be used to form a beam at each of the +/−45° polarizations. In contrast, using the H-V antenna element pairs to form +/−45° polarized beams as describe below avoids the limitation associated with using the +/−45° slant antenna element pairs, while still achieving the advantages associated with using +/−45° polarized beams.

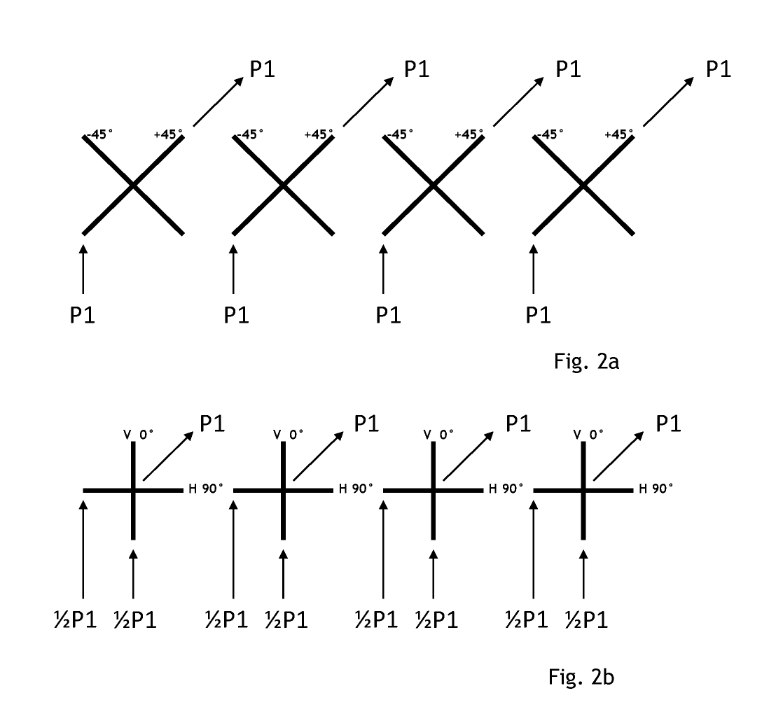

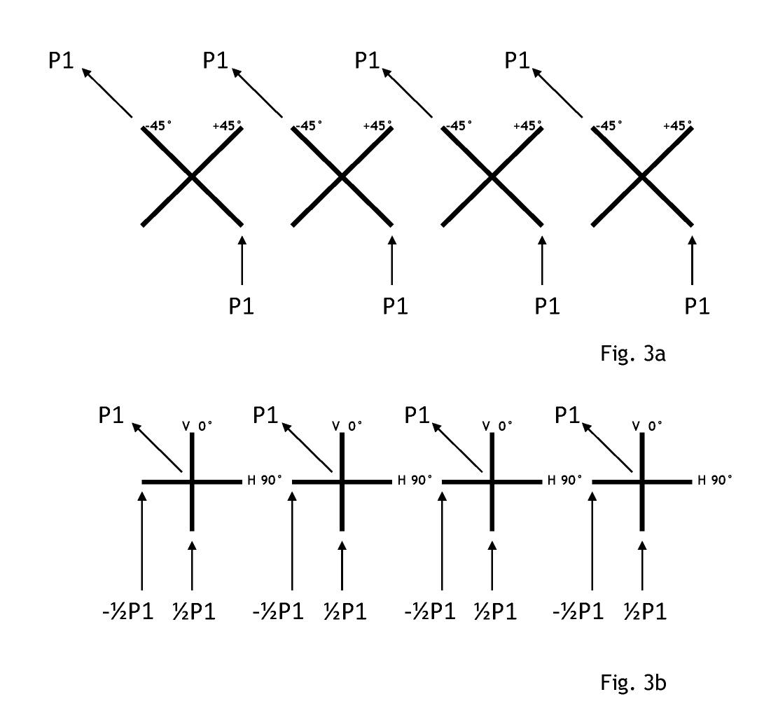

Using only four cross-polarized elements for simplification, FIGS. 2a and 2b and FIGS. 3a and b compare the two arrangements. The diagrams in FIGS. 2a and 3a show four +/−45° antenna elements; and FIGS. 2b and 3b show four 0°/90° antenna elements. To generate a narrow beam characterized by a +45° polarization, only the four +45° slant elements can be used (FIG. 2a). For obvious reasons, the −45° slant elements cannot be used because they have the wrong polarization. Assuming the maximum power that any antenna driver can deliver to its antenna element is P1, the maximum power that can be supplied to the +45° polarized beam is 4 P1. Similarly, to generate a narrow beam characterized by a −45° polarization, only the four −45° slant elements can be used (FIG. 3a) and the maximum power for that polarization is also 4 P1.

In contrast, if 0°/90° element pairs are used to construct the phased array (i.e., each element includes a 0° element and a 90° element), then all elements can be used to generate the desired +45° or −45° polarized beam. To generate a beam with +45° polarization, both the horizontal and vertical elements of any given pair of elements must be driven with equal power. For example, as shown in FIG. 2b, to generate a beam with a +45° polarization and total power of 4 P1, each horizontal element is driven with power of ½ P1 and each vertical element is driven with power of ½ P1. In other words, to generate such a beam, only half the power that each antenna driver is capable of delivering to its antenna element is required. Stated another way, by using the 0°/90° element pairs, the total power that can be delivered to a +45° polarized beam is twice that which can be delivered to such a beam using the +/−45° element pairs.

FIGS. 3a and 3b illustrate the case in which the array is used to generate a beam having a −45° polarization. In the case of the +/−45° antenna element pairs (see FIG. 3a), the −45° antenna element is driven. In the case of the 0°/90° antenna element pairs (FIG. 3b), the horizontally oriented antenna element is driven with a signal that is 180° out of phase with the signal that drives the vertically oriented antenna element.

Note that one way to look at the operation of the phased array that uses the 0/90° antenna element pairs is that it adds through superposition two identically-shaped and identically-directed beams, one with a 0° polarization and the other with a +90° polarization (or −90° polarization, whichever the case might be). The superposition, or vector addition of those two beams yields the desired +/−45° polarized beam.

A typical phased array is likely to use many more element pairs than four, but the same principles apply. For example, assume that there are 48 element pairs. If the element pairs are made up of +/−45° oriented antenna element pairs, then only 48 of the 96 antenna element inputs can be used to form a beam at a +45° polarization. Thus, only half of the total available amplifier power from the full set of antenna drivers can be used to form beams at the +45° polarization. Similarly, only half of the total available amplifier power can be used to form beams at the −45° polarization. In contrast, if H-V antenna element pairs are used, then all antenna elements (both the H element and the V element of each antenna element pair) can be recruited to form a beam having either a +45° polarization or a −45° polarization. Thus, the power that can be delivered to the resulting beam is twice that which can be delivered to the beam in the case of the phased array that employs +/−45° cross-polarized elements.

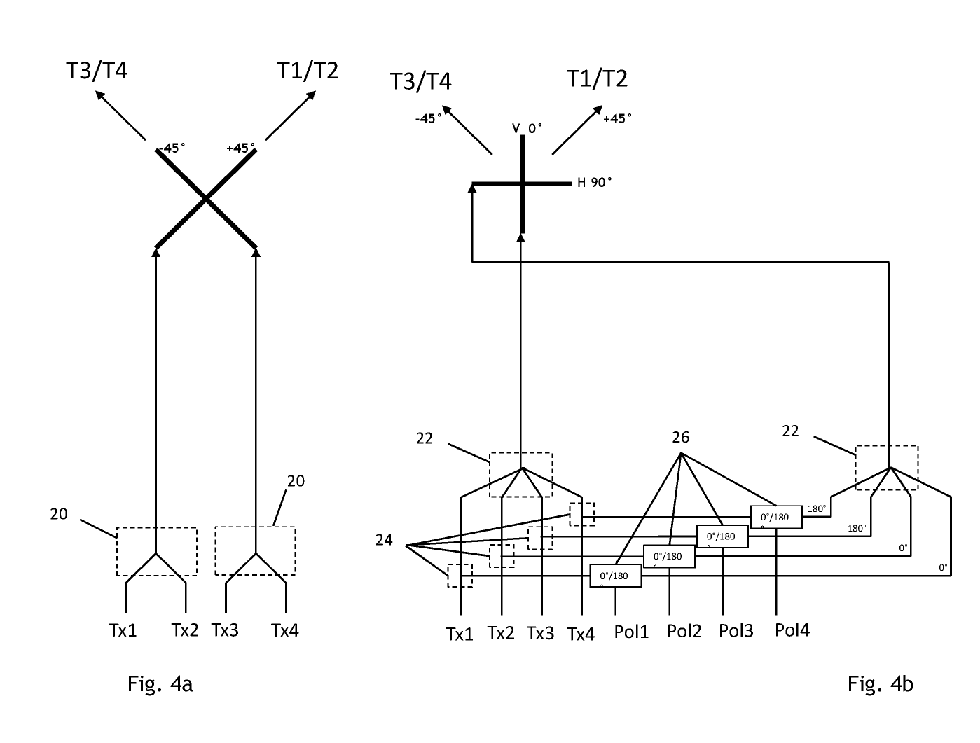

FIGS. 4a and 4b show diagrammatically part of a conventional phased array transmitter system (FIG. 4a) and part of a phased array transmitter system that implements the concepts described above (FIG. 4b). For simplicity, in these examples the signal paths in the signal distribution circuitry for only one antenna element pair within the antenna array are shown. It should be understood that the circuitry for driving all of the other element pairs of the multi-element phased array that are not shown in the figures is the same and performs the same functions as the circuitry which is represented by FIG. 4b. That is, the circuitry shown in FIG. 4b for driving on H-V antenna element pair is repeated for each H-V antenna element pair in the antenna array. Details about an exemplary implementation of the signal distribution circuitry are presented below.

In the configurations shown in FIGS. 4a and 4b, signals Tx1 and Tx2 are transmitted as +45° polarized beams and signals Tx3 and Tx4 are transmitted as −45° polarized beams. The circuit of FIG. 4a, which illustrates the conventional approach, includes a transmitter module 20 that processes the Tx1 and Tx2 signals to generate two corresponding signals T1 and T2, which are combined and sent to the +45° oriented antenna element of the cross-polarized antenna element pair and another transmitter module 20 that processes the Tx3 and Tx4 signals to generate two corresponding signals T3 and T4, which are combined and sent to the −45° oriented antenna element of that pair. In general, the transmitter modules 20 up-convert the signals to RF signals and applies appropriate phase and amplitude adjustments to each signal for generating the desired beams with the phased array. In this example, the four beams that are generated include two +45° polarized beams, one of T1 and the other for T2, and two −45° polarized beams, one for T3 and the other for T4.

In the circuit in FIG. 4b, the same set of beams is generated as is generated by the circuit of FIG. 4a (i.e., two +45° polarized beams for T1 and T2 and two −-45° polarized beams for T3 and T4) by using the H-V antenna element pairs instead of the +/−45° cross-polarized element pairs. In this case, all four signals Tx1, Tx2, Tx3, and Tx4 are sent to both antenna elements of each H-V antenna element pair. Towards this end, the circuit includes four splitters 24 for generating a second set of signals. One transmitter module 22 processes each of the four signals the Tx1, Tx2, Tx3, and Tx4, to generate four corresponding signals T1, T2, T3, and T4, which are combined and sent to the V-oriented antenna element of the H-V antenna element pair. For the H oriented antenna element, the circuit includes four 0°/180° phase shifters or phase setting circuits 26 for introducing a selectable 0° or 180° phase shift into each signal. In this example, the phase shifters 26 introduce a 180° phase shift into each of the Tx3 and Tx4 signals and then a transmitter module 22 processes each of the four signals (i.e., Tx1, Tx2, −Tx3 and −Tx4) to generate four corresponding signals T1, T2, −T3, and −T4, which are combined and sent to the H-oriented antenna element of the H-V antenna element pair. As described above, the transmitter modules up-convert the signals to RF and apply appropriate phase and amplitude adjustments to each signal for generating the desired beam for that signal with the phased array.

Since the phase shifters 24 need only be capable of introducing a 180° phase shift into a signal, they can be implemented by simple inverters instead of by using more complex, variable phase shifting circuits.

Note that at the different points in space where the antenna array generates a signal, the field generated by the H-oriented antenna element of an H-V pair and the field generated by the V-oriented antenna element of that H-V pair vectorially combine or add to yield a +/−45° polarized field.

It should be apparent from the above that to generate a cross-polarized beam from an array of H-V oriented antenna element pairs, the following general principles were applied. To generate the +45° polarized beam, for each H-V antenna element pair, identical signals were sent to both the H and V oriented antenna elements within a pair; whereas, to generate the −45° polarized beam, identical signals were sent to both the H-and V-oriented antenna elements of a pair, except for the possible introduction of a 180° phase shift into the signal sent to the H-oriented antenna element. Of course, the signals sent to different H-V antenna element pairs would typically not be the same because of the weight and amplitude adjustments required for beam shaping and beam directing by the phased array. Note that the same vector addition to synthesize +/−45° polarization from and H-V element can be accomplished by placing the selectable 0°/180° phase shift on the vertical (V) element rather than the horizontal (H) element or by placing some of the phase shifting elements on the vertical element and others on the horizontal element.

Viewed from a different perspective, in the example illustrated by FIG. 4b, the array of H-V antenna elements generates four pairs of transmit beams, with the two beams of each pair of beams being identically shaped and identically directed. Typically, each pair of beams is aimed in a different direction and/or has a different shape, as dictated by the coverage needs of the communication system. In addition, in each pair of transmit beams one beam is vertically polarized and the other beam is horizontally polarized and each of those two beams carries the same signal, except possibly for a phase difference of 180°. In other words, the phased array system generates: (1) vertically polarized and horizontally polarized beams for T1, which are identical in shape and direction; (2) vertically polarized and horizontally polarized beams for T2, which are identical in shape and direction; (3) vertically polarized and horizontally polarized beams for T3, which are identical in shape and direction; and (4) vertically polarized and horizontally polarized beams for T4 which are identical in shape and direction. For each signal, the H polarized and V polarized beams, being identical in shape and direction, will vectorially add (or combine) to form a single beam having the desired +45° or −45° polarization.

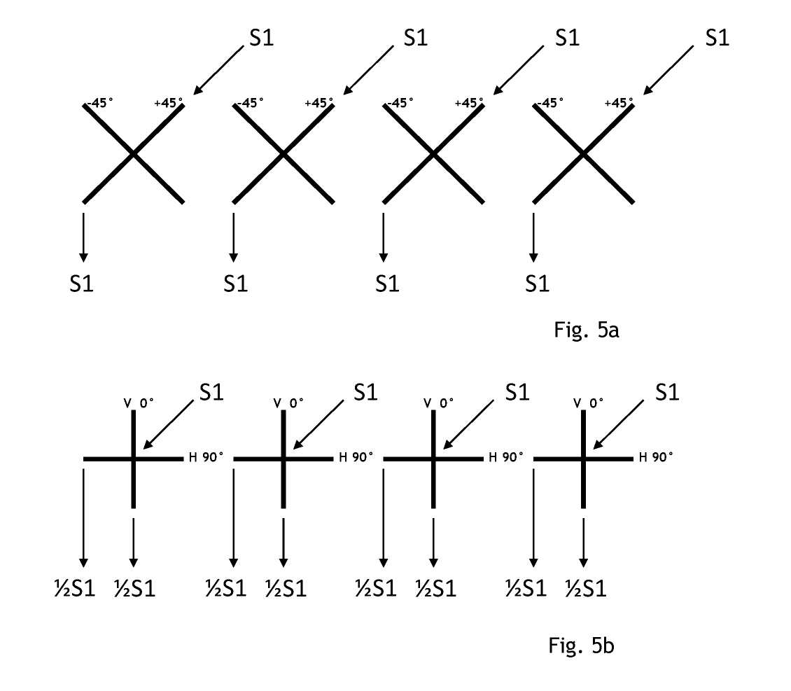

Note that the above-described concepts also apply to the receiver side of the system. In a conventional system which employs cross-polarized antenna element pairs, as depicted in FIG. 5a, the +45° slant antenna elements of the antenna array are used to receive the +45° polarized beam signal having signal strength S1. In the system that uses the array of H-V element pairs, as depicted in FIG. 5b, both the H-oriented antenna element and the V-oriented antenna element receive part of the power of a +45° polarized transmission. More precisely, each H-oriented and V-oriented antenna element receives half the power that would be received by a +45° slant oriented antenna element. The receiver circuitry then combines the signals received by the H-oriented and V-oriented antenna elements.

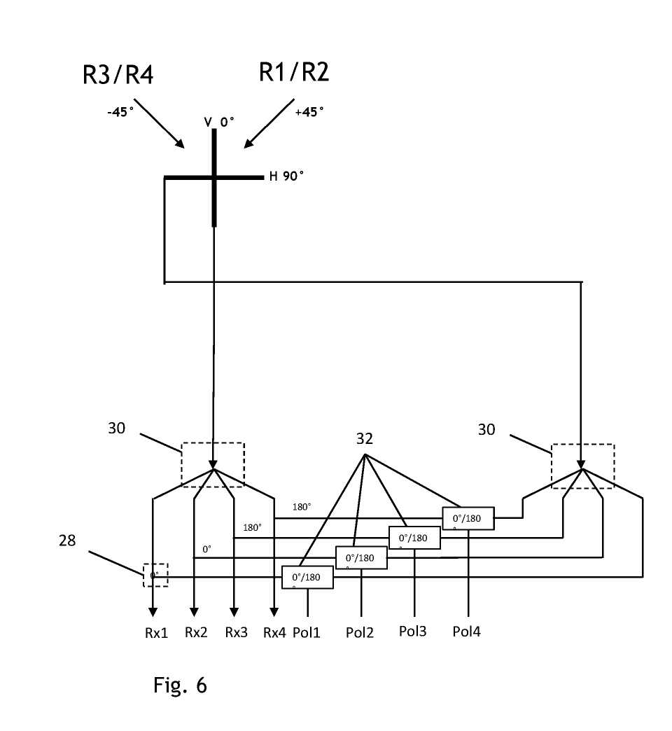

FIG. 6 shows part of a wireless receiver system that employs an array of H-V antenna element pairs. The circuitry that is illustrated represents the circuitry for one H-V antenna element pair. It should be understood that the illustrated circuitry is repeated for each H-V antenna element pair in the antenna array. The circuitry operates basically the same as the phased array transmitter system shown in FIG. 4b, but in reverse. A receiver module 30 processes the received signals R1, R2, R3 and R4 from the V-oriented antenna element to generate four corresponding signals, namely, Rx1, Rx2, Rx3 and Rx4. The processing involves down-converting each of the received signals and apply the appropriate phase and amplitude adjustments for the corresponding desired receiving beam pattern. Another receiver module 30 processes the received signals from the H-oriented antenna element, namely, R1, R2, −R3 and −R4 to generate four corresponding signals, namely, Rx1, Rx2, −Rx3 and −Rx4. (The R3 and R4 signals have negative signs in this example because the received signals had −45° polarizations.) Phase shifters 32, which are capable of introducing a selectable phase shift of 0° or 180°, shift the phases of the R3 and R4 signals by 180°. Then each of the resulting signals is combined via corresponding combiners 28 with its corresponding signal from the V-oriented antenna element. In this way, the system of FIG. 6 operates as if it were using cross-polarized antenna elements to receive the signals.

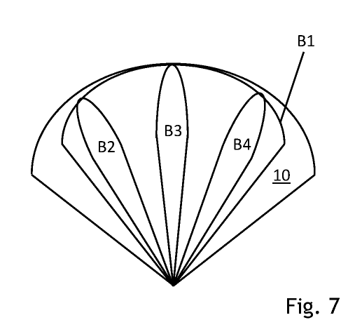

FIG. 7 presents an example that further illustrates an advantage of the architecture and method of synthesis described herein. Consider a phased array system with 160 W of total available power, covering a sector 10 with a wide beam for blanket coverage (B1) and covering the rest of the cell with three additional narrow beams (B2, B3, and B4). Suppose also that it was advantageous from a diversity gain standpoint to have the three narrow beams B2, B3, and B4 be transmitted with opposite polarity to that of the wide beam B1. With the architecture that employs the cross-polarized elements, the maximum power available for the wide beam would be 80 W and the remaining 80 W would need to be split between the three narrow beams. With the new architecture and new way of synthesizing the cross-polarized beams, the entire available 160 W could be split arbitrarily across all four beams. For example, 40 W for the wide beam B1 and 40 W for each narrow beam B2, B3, and B4, yielding a 75/25 split across polarizations.

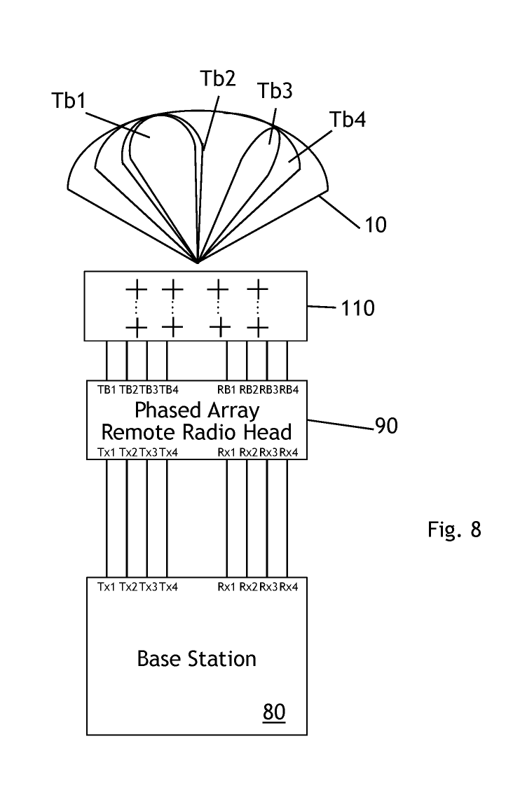

FIG. 8 illustrates a phased array antenna system that employs a phased array antenna 110 made up of a one or two-dimensional array of H-V antenna element pairs. It includes a base station 80 that communicates with a remote phased array radio head 90 connected to the phased array antenna 110. In this system, multiple beams can be formed within a sector, some perhaps overlapping and some not. In this particular embodiment, the base station 80 sends four transmit signal streams Tx1 Tx2, Tx3, and Tx4 to the remote radio head 90 and receives from the remote radio head 90 four received signal streams Rx1, Rx2, Rx3, and Rx4. The remote radio head 90, in turn, sends four transmit beam signal streams Tb1, Tb2, Tb3, and Tb4, to the antenna array 110 to generate four beams, one beam for each transmit beam signal stream, and it receives four signal streams Rb1, Rb2, Rb3, and Rb4 from the antenna array 110.

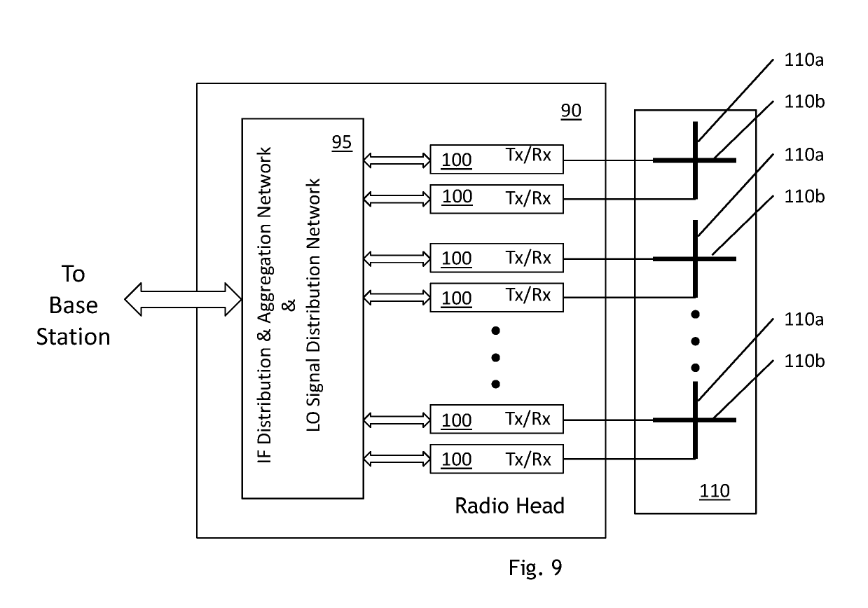

The details of an exemplary active antenna array system that can be used in the system of FIG. 8 are presented in FIGS. 9, 10, 11, and 12. It should be understood that the figures illustrate just one example of many different possible ways of implementing an active antenna array system including analog implementations as well as digital implementations.

Referring to FIG. 9, the antenna array 110 includes an array of M H-V antenna element pairs, each antenna element pair including a vertically oriented antenna element 110a for generating a vertically polarized transmit beam and a horizontally oriented antenna element 110b for generating a horizontally polarized transmit beam. The radio head 90 includes multiple front-end modules (Tx/Rx modules) 100, equal in number to the number of antenna elements in the array, namely, 2M. There are two Tx/Rx modules 100 for each H-V antenna element pair, one Tx/Rx module 100 connected to the H-oriented antenna element 110b and the other Tx/Rx module 100 connected to the V-oriented antenna element 110a. There is also a signal distribution network 95 that includes an IF distribution and aggregation network and an LO signal distribution network. This signal distribution network 95 delivers transmit signals from the base station to the Tx/Rx modules 100, delvers received signals from the Tx/Rx modules 100 to the base station, and provides coherent local oscillator signals to the Tx/Rx modules 100 for up-converting IF transmit signals to RF transmit signals and for down-converting RF received signals to IF received signals.

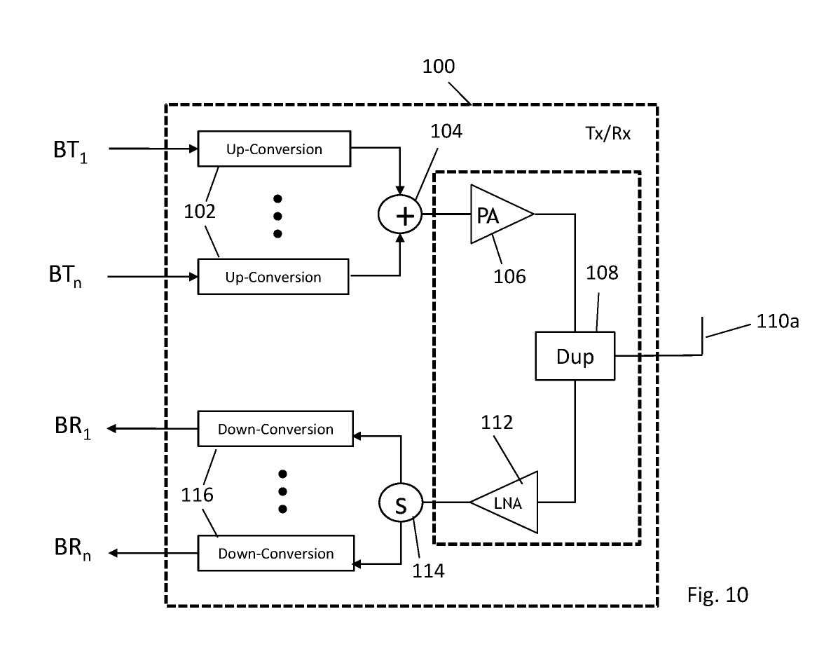

FIG. 10 is a block diagram of the front-end or Tx/Rx module 100 that connects to a single vertically oriented antenna element 110a of the multi-element antenna array. It includes a transmitter side and a receiver side. The transmitter side includes N up-conversion modules 102, a combiner circuit 104 (e.g. a Wilkinson type combiner), and a power amplifier (PA) 106. The receiver side includes a low noise amplifier (LNA) 112, a splitter 114 (e.g. a Wilkinson type splitter), and N down-conversion modules 116. The front-end module 100 also includes a duplexer circuit 108 that couples the transmit signal from the PA 106 on the transmitter side to the antenna element 110a and couples a received signal from the antenna element 110a to the LNA 112 on the receiver side. The input of each up-conversion module 102 is for receiving a different beam transmit signal stream BT₁ . . . BTₙ from the baseband unit (not shown). And the output of each down-conversion module 116 is for outputting a different beam received signal stream BR₁ . . . BRₙ. Typically, each beam transmit signal stream is mapped to a different beam that is generated by the active antenna array system and each received signal stream corresponds to the signal received by a different receive beam formed by the active antenna array.

The antenna array system of FIG. 9 that employs the Tx/Rx module 100 is capable of generating N 0° polarized beams and N 180° polarized beams, which when combined form N +/−45° polarized beams, each of which carries a different transmit signal.

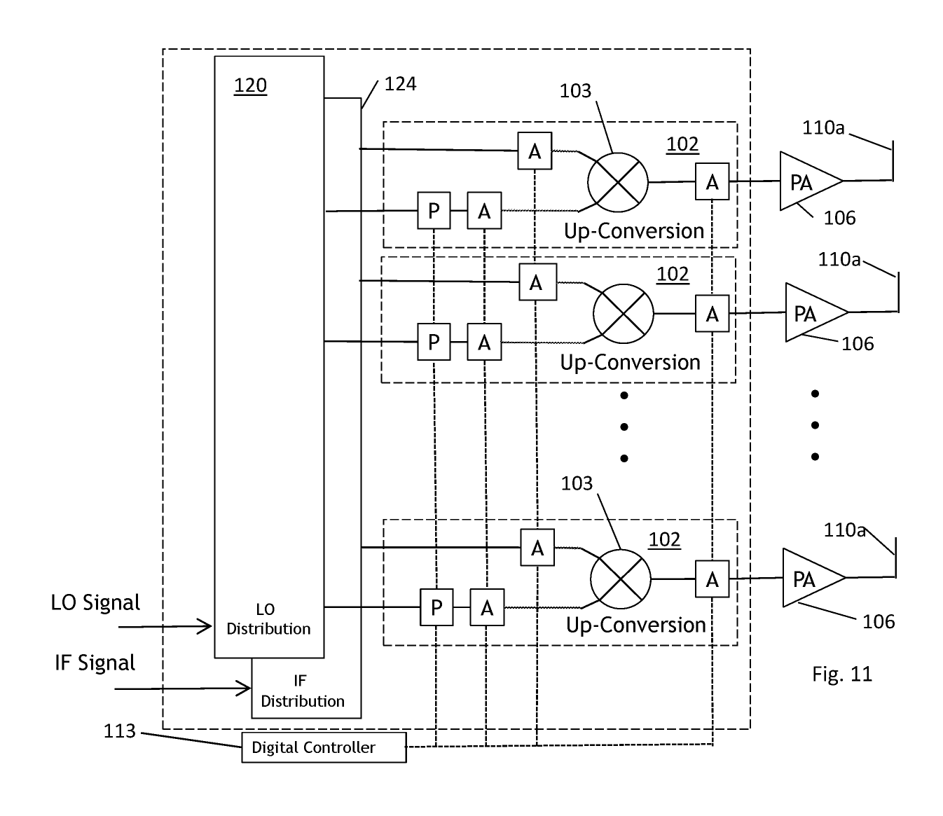

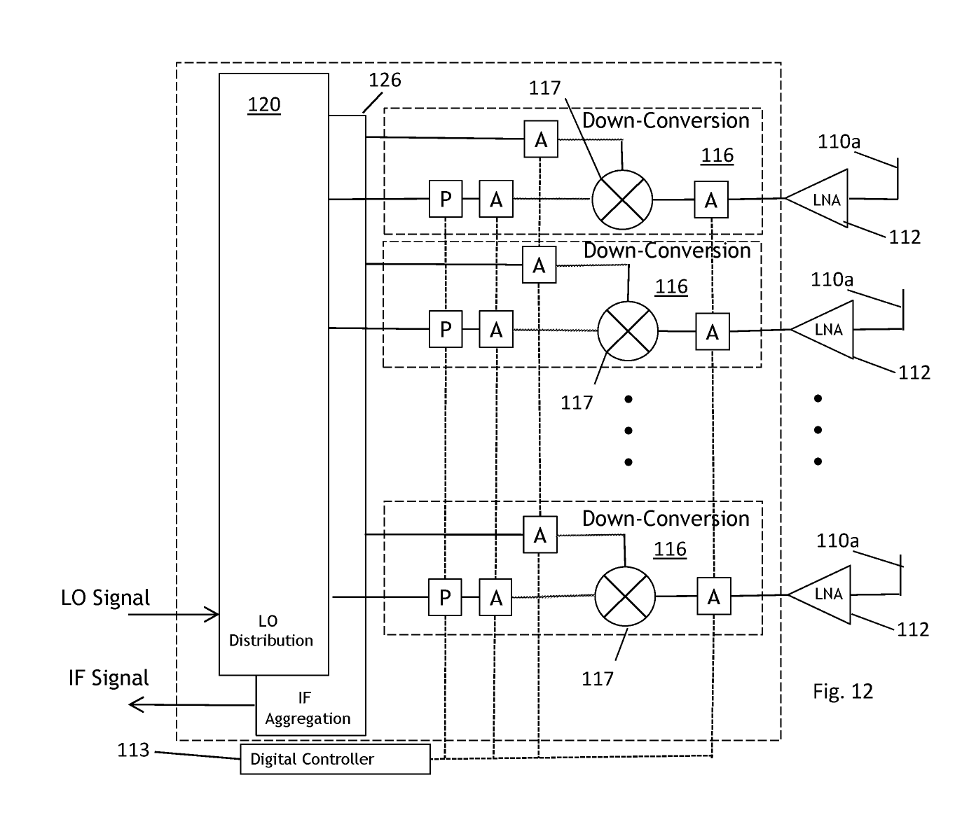

An active antenna array system in which the up-conversion modules 102 on the transmitter side are shown in greater detail is depicted in FIG. 11; and an active antenna array system in which the down-conversion modules 116 on the receiver side are shown in greater detail is depicted in FIG. 12. These transmitter side system and the receiver side system are shown separately in FIGS. 11 and 12 to simplify the figures. But as should be apparent from FIG. 10, both transmitter side and receiver side systems are present in the front-end. Also, it should be noted that for simplicity FIG. 11 only shows one up-conversion module 102 and no combiner 104 (see FIG. 10) for each vertically oriented antenna element that is depicted and FIG. 12 only shows one down-conversion module 116 and no splitter 114 (see FIG. 10) for each vertically oriented antenna element. As should be apparent from FIG. 10, in the complete system there are multiple up-conversion modules 102 and a combiner 104 for each antenna element and there are multiple down-conversion modules 116 and a splitter 114 for each antenna element.

The active antenna array system of FIG. 11 is for transmitting a signal stream over a single transmit beam that is generated by the M vertically oriented antenna elements 110a of the antenna array (where M is an integer that is greater 1). Similarly, the active antenna array system of FIG. 12 is for receiving a signal stream on a single receive beam pattern that is generated by the antenna array.

Referring to FIGS. 11 and 12, there is an LO distribution network 120 for distributing a coherent or phase-synchronized LO signal to the M up-conversion modules 102 and the M down-conversion modules 116. As shown in FIG. 11, there is also an IF distribution network 124 for delivering the IF transmit signal to each of the up-conversion modules 102. And as shown in FIG. 12, there is an IF aggregation network 126 for aggregating the received signals from each of the down-conversion modules 116.

The distribution and aggregation networks may be passive linear reciprocal networks with electrically identical paths to ensure the coherent distribution/aggregation of signals. Alternatively, one or more of these networks may be implemented using the bidirectional signaling network described in U.S. Pat. No. 8,259,884, entitled “ Method and System for Multi-Point Signal Generation with Phase Synchronized Local Carriers,” filed Jul. 21, 2008 and U.S. Pat. No. 8,611,959, entitled “Low Cost, Active Antenna Arrays,” filed Jun. 30, 2011 or the serial interconnection approach described in U.S. Ser. No. 15/259,639, entitled “Calibrating a Serial Interconnection,” filed Sep. 8, 2016, the contents of all of which are incorporated herein by reference.

Each up-conversion module 102 includes a mixer 103 and various amplitude and phase setting circuits identified by A and P, respectively. The LO signal and the distributed IF transmit signal stream are both provided to the mixer 103 which up-converts the IF transmit signal stream to an RF transmit signal stream that is provided to the power amplifier 106. Similarly, each down-conversion module 116 also includes a mixer 117 and various amplitude and phase setting circuits similarly identified by A and P, respectively. The mixer 117 in the down-conversion module 116 multiplies the LO signal provided by the LO distribution network 120 and the received RF signal stream from the low noise amplifier 112 that is coupled to the antenna element 110a to generate a down-converted IF received signal stream. The down-converted IF signal stream is provided to the IF aggregation network 126 for aggregation with the IF received signal streams from the other antenna elements and for delivery back to the base station.

The amplitude and phase setting circuits A and P are used for changing the relative phase or amplitude of individual antenna signals to thereby establish the size, direction, and intensity of the transmit and receive beam patterns that are generated by the antenna array. (Note: In an antenna array, a transmit beam is a radiation pattern that is generated by the antenna array. That radiation pattern can be measured in front of the antenna array. In contrast, a receive beam is not a radiation pattern formed by the antenna array but rather is a pattern of antenna sensitivity. Nevertheless, in spite of this difference, they are both generally referred to as beams.) The amplitude setting circuit is basically equivalent to a variable gain amplifier, in which the ratio of the output signal amplitude to the input signal amplitude is programmable and is set by electronic control. The phase setting circuit has the fundamental capability of shifting the input signal in phase (or time) under electronic control. These amplitude and phase setting circuits are controlled by digital control signals supplied by a separate control processor 113.

The typology of the amplitude setting and phase setting circuits shown in FIGS. 11 and 12 is just one of many possibilities for giving the basic transmitter and receiver the capability to control independently the amplitude and phase values of the individual antenna signals. The number and placement of the amplitude and phase setting circuits can vary from what is illustrated in FIGS. 11 and 12 and depends on the implementation approach that is employed. In addition, there are other components which might be present in the up-conversion and down-conversion modules but which are not shown in the figures because they are well known to persons skilled in the art. These might include, for example, channel IF filters and automatic gain controls.

The synthesis of a single +45° or −45° polarized, steerable beam by using a phased array antenna system having M H-V antenna element pairs such as was described above can be summarized as follows. The vertically-oriented antenna elements of N H-V antenna element pairs among the M H-V antenna element pairs are used to generate a vertically polarized beam BV and the horizontally-oriented antenna elements of the N H-V antenna element pairs are used to generate a horizontally polarized beam BH. The two beams BV and BH are generated so that the vertically polarized beam BV and the horizontally polarized beam BH have essentially identical shapes and beam directions so that their superposition or vectoral combination produces the desired +/−45° polarized beam. In this description, M and N are assumed to be integers, M being the number of antenna element pairs within the phased array and N being the number of antenna element pairs within the phased array that are used to generate the beam. The M antenna element pairs can be arranged linearly or in a two-dimensional pattern. N is greater than one and less than or equal to M, where M is at least 2. Typically, N=M meaning that the entire array is used to generate the beam; but that need not be the case.

From the perspective of each H-V antenna element pair of the M H-V antenna element pairs, this means that identical signals are sent to the two antenna elements (i.e., the H element and the V element) of a given H-V antenna element pair, except for a possible 180° phase shift applied to one of the two signals. In contrast, the signals that are sent to different H-V element pairs among the M H-V antenna element pairs may be, and likely are different, and are determined by the beam-shaping, beam-directing, and beam steering that is performed by the phased antenna array system.

The more general case of using a phased array antenna system having M H-V antenna element pairs to synthesize multiple cross-polarized, steerable beams Bj, where j=1 . . . n (n being the number of beams) and where each cross-polarized beam Bj has either a +45° polarization or a −45° polarization can be summarized as follows. For each cross-polarized beam Bj, the vertically-oriented antenna elements of Nj H-V antenna element pairs among the M H-V antenna element pairs are used to generate a vertically polarized beam BVj and the horizontally-oriented antenna elements of the same Nj H-V antenna element pairs are used to generate a horizontally polarized beam BHj. The two beams BVj and BHj are generated so that the vertically polarized beam BVj and the horizontally polarized beam BHj have essentially identical shapes and beam directions so that their superposition produces the desired +/−45° polarized beam, Bj.

As with the case of generating a single cross-polarized beam described above, M and Nj are assumed to be integers, the M elements of the phased array can be arranged linearly or in a two-dimensional pattern, Nj is an integer that is greater than one and less than or equal to M, and n is an integer.

Also as in the case of the single cross-polarized beam described above, from the perspective of each H-V antenna element pair of the M H-V antenna element pairs, this still means that identical signals are sent to the two antenna elements (i.e., the H element and the V element) of a given H-V antenna element pair, except for a possible 180° phase shift applied to one of the two signals. And again, the signals that are sent to different H-V element pairs among the M H-V antenna element pairs may be, and likely are different, as they are determined by the beam-shaping, beam-directing, and beam steering that is performed by the phased antenna array system.

Other embodiments are within the following claims. For example, though the 0°/180° phase shifters were shown as separate modules located in the signal path before the transmitter modules or the signal path after the receiver module, they could be located elsewhere in the signal path at any location before the combiner, in the case of the transmitter path, or after the splitter, in the case of the receiver path. Alternatively, the appropriate 180° phase shifts can be introduced using the phase setting components in the transceivers. In addition, instead of having all of the phase shifters being located in the signal paths to the horizontally oriented antenna elements, they could all be in the signal paths to the vertically oriented antenna elements or they could be in both paths.

What is claimed is:

1. A method comprising:
providing a phased array antenna system having M antenna element pairs, each antenna element pair including a vertically oriented antenna element and a horizontally oriented antenna element, wherein M is an integer greater than 1; and
with the phased array antenna system, generating n cross-polarized beams Bj, where j=1 . . . n, each cross-polarized beam Bj having either a +45° polarization or a −45° polarization and wherein n is an integer equal to or greater than 1,
wherein generating each cross-polarized beam Bj comprises:
with the vertically polarized antenna elements of Nj antenna element pairs among the M antenna element pairs, wherein Nj is an integer, generating a vertically polarized beam BVj; and
with the horizontally polarized antenna elements of the Nj antenna element pairs, generating a horizontally polarized beam BHj,
wherein the vertically polarized beam BVj and the horizontally polarized beam BHj are identically shaped and directed and wherein a superposition of the beams BVj and BHj produces the cross-polarized beam Bj, and
wherein Nj for j=1 . . . n is an integer such 2≦Nj≦5 M.

2. The method of claim 1, wherein n=1.

3. The method of claim 1, wherein n>1.

4. The method of claim 1, wherein at least one Nj of the Nj for j=1 . . . n equals M.

5. The method of claim 1, wherein each Nj for j=1, . . . n equals M.

6. The method of claim 1, wherein the M antenna element pairs are arranged to form a one-dimensional array.

7. The method of claim 1, wherein the M antenna element pairs are arranged to form a two-dimensional array.

8. The method of claim 1, wherein then cross-polarized beams Bj, for j=1 . . . n, are transmit beams.

9. The method of claim 1, wherein the n cross-polarized beams Bj, for j=1 . . . n, are receive beams.

10. The method of claim 1, wherein each cross-polarized beam Bj, for j=1 . . . n, is aimed in a different direction.

11. The method of claim 1, wherein a subset of the n cross-polarized beams Bj, for j=1 . . . n has a +45° polarization and a different subset of the n cross-polarized beams Bj, for j=1 . . . n has a −45° polarization.

12. The method of claim 1, wherein generating the vertically polarized beam BVj comprises generating the vertically polarized beam BVj for a signal transmission Tj and wherein generating the horizontally polarized beam BHj comprises generating the horizontally polarized beam BHj for the signal transmission Tj with either a 0° or 180° phase shift.

13. The method of claim 1, wherein generating the horizontally polarized beam BHj comprises generating the horizontally polarized beam BHj for a signal transmission Tj and wherein generating the vertically polarized beam BVj comprises generating the vertically polarized beam BVj for the signal transmission Tj with either a 0° or 180° phase shift.

14. The method of claim 2, wherein generating the vertically polarized beam BV1 comprises generating the vertically polarized beam BV1 for a signal transmission T1 and wherein generating the horizontally polarized beam BH1 comprises generating the horizontally polarized beam BH1 for the signal transmission T1 with either a 0° or 180° phase shift.

15. The method of claim 2, wherein generating the horizontally polarized beam BHj comprises generating the horizontally polarized beam BHj for a signal transmission Tj and wherein generating the vertically polarized beam BVj comprises generating the vertically polarized beam BVj for the signal transmission Tj with either a 0° or 180° phase shift.
